(19) United States
(12) Patent Application Publication
(10) Pub. No.: US 2012/0197992 A1
(43) Pub. Date: Aug. 2, 2012

(54) SYSTEM AND METHOD FOR CREATING A MEDIA RICH, LINEAR AND NON-LINEAR, INTERACTIVE COMMUNICATION, EDUCATION, STORYTELLING ENVIRONMENT AND DEVELOPMENT TOOLS THEREFOR

(76) Inventors: Benjamin R. Meyer, San Francisco, CA (US); Jeremy M. Schneider, San Francisco, CA (US); Stephen A. Fung, San Francisco, CA (US)

(21) Appl. No.: 13/356,452

(22) Filed: Jan. 23, 2012

Related U.S. Application Data
(60) Provisional application No. 61/436,705, filed on Jan. 27, 2011.

(51) Int. Cl. G06F 15/16

(52) U.S. Cl. 709/204

(57) ABSTRACT

A customizable communication, storytelling and learning environment with a storyline or flow path with one or more plots and/or subplots and story branch or transition points and one or more endings for individuals and groups that is delivered with various media, over various media channels, at various times and intervals by use of a triggered communications server and method and producer development kit therefor.

### CLAIM TO PRIORITY

This application claims benefit to U.S. Provisional Application No. 61/436,705, filed Jan. 27, 2011, which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

Embodiments of the invention are generally related to systems and methods for presenting a story or series of events and having a user interact with the story or series of events.

### BACKGROUND OF INVENTION

Down through the evolution of mankind, storytelling and communication of history, facts, lore, and community have taken a number of forms that have evolved with time and technology. At times such storytelling communications has been broadcast to many and also customized and communicated to one or a few. Initially, such storytelling communications started with roaming story telling people that performed acts and plays. As technology evolved, print media was used for this type of communication. Following print media, radio, films and television technology were used for storytelling and communication. Presently, online media in many forms is used in conjunction with all of the other mechanisms for storytelling and communication.

Often times the evolution of such communication mechanisms simply incorporate past storytelling techniques into new technology without using the benefits and advantages of the new technology, and without adapting prior storytelling communications for the new communication technologies.

By way of example, storytelling is the conveying of events in words, images and sounds, often by improvisation or embellishment. Stories or narratives have been shared in every culture as a means of entertainment, education, cultural preservation and in order to instill moral values. Elements of stories and storytelling include plot, characters and narrative point of view to name a few.

### SUMMARY OF THE INVENTION

Embodiments of the present invention include systems and methods, which include hardware and/or software for customizing media rich, interactive, linear and non-linear storytelling communication for broadcast to many and also for sending a customized story or communication to as few as one user crafted to the personal profile, interests, behaviors and choices of that one user. Embodiments of the present invention provide a tool kit and sublicensing platform for media producers.

For customizing the storytelling and communication experience for one or many users, embodiments of the present invention allow different forms of medium and/or events, and/or media communication channels to be used. The forms can be email, text messages, facsimile, cable, pagers, social media networks, voice and telecommunications messages, video and other types of visual and audio messages, physical objects used as messages, and personal interactions with others. All of these forms can be used as part of the interactive, linear and non-linear, storytelling and communication process.

Based on the storyline and on input from the one or more users, communication of the media, or events can be triggered and/or otherwise sent in a timed, sequenced, linear, non-linear and/or random manner to the users. The response of the user to any such media or event can trigger or effect the next communication or form of communication received by the user.

Accordingly, embodiments of the present invention are directed to systems and methods for creating an interactive and, linear and/or non-linear, media rich communication environment and development tools therefor. The communication environment can be a story telling environment, an education or learning environment, a training environment or any other environment that is interactive and rich with media of all types and origins and content. Media can include media in the forms for example of audio, video, audio and video, text, email, snail mail, SMS/MMS, voice mail, physical (tough and three dimensional), chemical and the like and can affect all the senses including, sight, hearing, smell, tough and taste. The embodiments can be use by a single user or by multiple users acting alone or interactively in concert. The media can be provided by all types of storage devices as well as by live actors and performers that appear in the environment of the user or participant.

The user's profile, either initially input to embodiments of the invention or as created or evolved and stored on, for example, a social media site, can also be the basis for part of the selections and interactive in the storytelling and communication experience.

Additionally, prior storytelling and communication environments are not adapted to present user engagement patterns. The present embodiments consider multitasking and behaviors in order to better provide environments that allow media and events to be communicated to a user when the user wants the input in accordance with the user's multitasking behaviors instead of as selected by the producer of the storyline and communications. Presently, media, especially media communicated over the internet, tends to be provided in short messages or segments which often become highly interactive dialogs between two or more participants. Internet, telecommunication and other channels allow producers and content creators to customize and personalize experiences for users that are delivered to users according to the behavior patterns of the users in accordance with embodiments of the invention.

Thus, embodiments of the present invention allow publishers to publish and provide content and media and events that are customized and dynamically respond to the consumption patterns and behaviors of individual users and one or more groups of users.

Accordingly, such media can be served up to the user in short interactive segments that can fit more easily and conveniently into the life style of a user who is becoming increasing used to multi-tasking and absorbing and processing information and media from various sources in various orders. Such media is consistent with the trend by users to consume shorter segments of information that fit into their schedule.

### BRIEF DESCRIPTION OF THE DRAWINGS

FIG. 1 depicts an architectural schematic of an embodiment of the present system and method of the invention including an embodiment of a triggered communication server.

FIG. 2 depicts an architectural schematic of an embodiment of the present system and method of the invention including input and output modules for accepting information and delivering information.

FIG. 3 depicts an architectural schematic of an embodiment of the present system and method of the invention with various communication modules.

FIGS. 4 through 12c depict a dashboard and input steps for use by a producer of a story telling communication in accordance with producer tools of embodiments of the invention.

### DETAILED DESCRIPTION OF THE PREFERRED EMBODIMENTS

The invention is illustrated, by way of example and not by way of limitation, in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details will be set forth to provide a thorough description of the invention. However, it will be apparent to those skilled in the art that the invention and embodiments thereof may be practiced without these specific details. In other instances, well-known features have not been described in detail so as not to obscure the invention.

### Triggered Communication Server

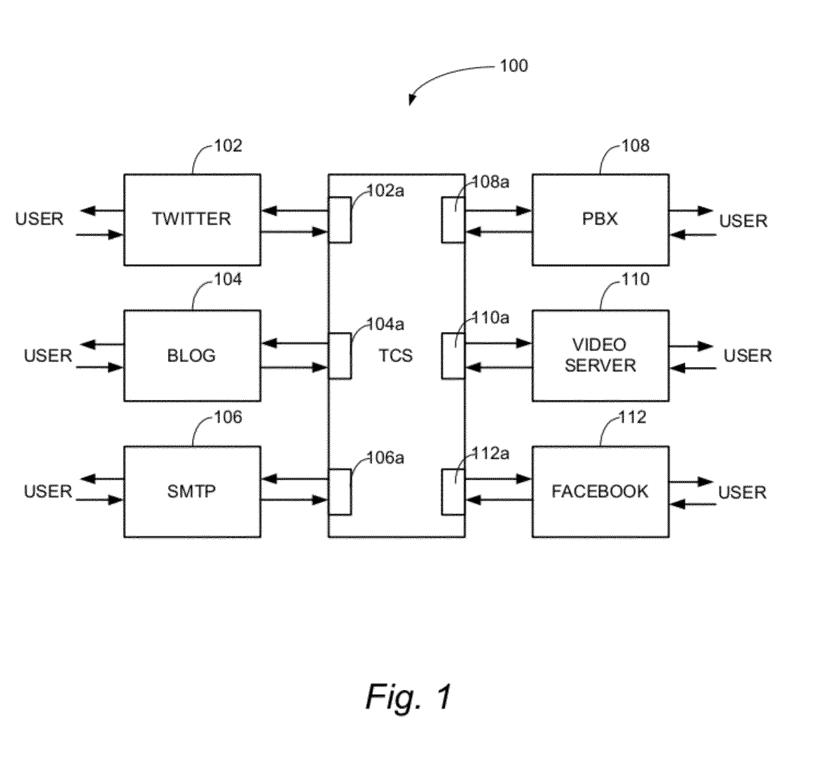

FIG. 1 depicts an architectural schematic of an embodiment of the invention with a triggered communication server (TCS) which can deliver various types of media and information to a user interactively, linearly and non-linearly using a multitude of communication channels. The triggered communication server is responsible for maintaining storyline status for users and triggering storyline events from each media outlet. The TCS product is able to integrate with multiple social networks and communications mediums, and publish content to each of them and receive context from them based on both time and event triggers. The triggered communication server allows for simultaneous and non-simultaneous, interactively, linear and non-linearly consumption of events, data and content. Thus, for example, not every user experiences the story at the same time with the same sequence of events, and every user can experience a different story, and the same or different stories can be broadcast to a plurality of users or groups of users.

In one embodiment, the triggered communication server controls modules or adaptors that can communicate with various communication channels or media outlets or API's for delivering media and content to the user and for the user to interact with the system, and, in particular, with the triggered communication server. The various communication channels include by way of example only Twitter® and Twitter® messages, blogs and other types of internet communications such as YouTube® communications, Simple Mail Transfer Protocol (SMTP) and email communications, Private Branch Exchange (PBX), VOIP and other types of voice or audio communications, video server communications, FaceBook® communications, and other adapters, modules and channels for delivering content to and from the user. Accordingly, by way of example, FIG. 1 depicts a Twitter® Module 102, a Blog Module 104, a SMTP Module 106, a PBX® Module 108, a Video Server Module 110, and a Facebook® 112 Module. It is to be understood that many other types of modules can be included such as a Google® Module, a Google Plus® Module, a Yahoo® Module, a YouTube® Module, a flickr® module, a Wikipedia® Module, email modules, voicemail modules, text messaging modules and the like for providing input to and output from the TCS 100. These modules are external to the TCS 100, and, are, for example, external applications or servers that can run on their own in isolation. These Modules can handle the flow of information and data to and from the user.

In embodiments of the invention, the triggered communication server can trigger the timing of certain content delivery to the user in accordance with, for example, the storyline, the user's profile and the user's input or response to a communication sent to the user and/or randomly In the same and other embodiments the triggered communication server can unlock URL's or send links to URL's that provide other communications meant for the user in accordance with the story. In addition, and, by further way of example of communications that can be sent to, and received from the user, the triggered communication server can cause the scheduling of live events that the user can participate in. Such live events, can be plays or interaction with live actors at actual locations established by the story. Further, the server can trigger the shipment of physical objects, merchandise, prizes and rewards to the user that have relevance to the storyline. Additionally, in a story sponsored by a producer, advertiser or the maker or sponsor of a product, materials and communications from the producer, advertiser or product sponsor can include objects, merchandise, prizes and rewards representative of the producer, advertiser or product sponsor, sent to the user, so that the user can obtain the items as part of the user's participation in the story and communication.

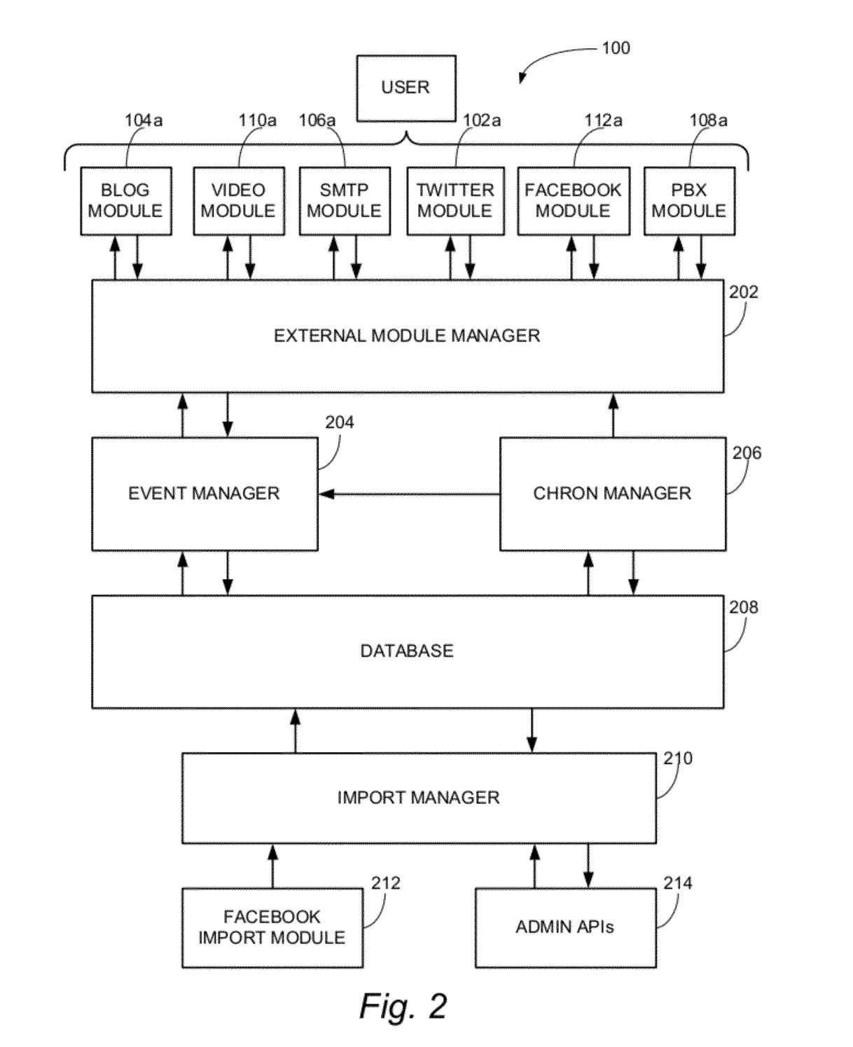

FIG. 2 depicts an architectural schematic of an embodiment of the invention including input and output modules for accepting information and delivering information that is part of the triggered communication server 100 of FIG. 1. In FIG. 2, each of the controller modules at the top (i.e. the Twitter® Module 102a, the Blog Module 104a, the SMTP Module 106a, the PBX® Module 108a, the Video Server Module 110a and the Facebook® Module 112a are) is the connecting point from the TCS module of FIG. 1 to the other similarly named modules in FIG. 1. In a preferred embodiment, the TCS 100 includes the modules, managers and other elements of FIG. 2. Embodiments of the invention integrate with the various API's of numerous third party social networks and communication mediums, as discussed above. In this manner, these embodiments handle the flow of data information, objects and/or events to and from the user. As seen in FIGS. 1 and 2, each of the social networks and communication mediums has its own separate controller modules, which are responsible for any protocols required to talk to third party servers, and have sets of internal API's available with which to interact with an external module manager 202. Two-way input and output data communications are established between the controller modules 102, 104, 106, 108, 110, 112 and the external module managers 202. Accordingly, in this embodiment, content and messages can be sent to or pushed to the users from the triggered communication server 100 through the controller modules. This external module manager 202 can then funnel all user data or other requests down onto the event manager 204 and the chron manager 206. Further content and messages from the user is communicated through the modules to the triggered communications server 100. Having such an architecture design allows the TCS server to integrate with any new social networks and mediums that may gain popularity in the future. Embodiments of the invention, rely on interactive experiences, so the embodiments are reliable in timing and delivery of content to end users. Additionally, as stated above, the embodiments interface with many different third party APIs, such as Facebook® and Twitter®, and have modules for working with SMTP and PBX. The system can scale on the magnitude of thousands and hundreds of thousands and millions of users. Only a few dozen of those may need to do direct interactions with the user interface, the rest can be interacting mostly through social media channels and be mostly the target of content pushes.

In FIG. 2, the event manager 204 manages the user input process, the transaction process, and sessions with state. The event manager 204 keeps track of the transaction process to ensure that events occur when, for example, the events are triggered. The chron manager 206 is, in this embodiment, a time line manager that manages the time line of the story.

Also depicted in FIG. 2, a database 208 is used to store content, instructions, event triggers, user information, user profiles, storylines, story chronologies, and other information relevant to the content and flow of the story, or messages or communication or information or things exchanged between the user and the system. Such content can include, by way of example, video, audio, text and other forms of content. The database can also store addresses or URL's for content. In order to control all data going into the database in one embodiment, access can be restricted to a limited number of modules, namely, the event manager 204, the chron manager 206, and the import manager 210.

As indicated above, also communicating with the database is the import manager 210. The import manager is responsible for adding rows to the database. The import manager provides APIs for adding and modifying entries to all the database tables. This import manager 210 adds data to the database through the use of import modules, such as social network modules as Facebook®, also referred to as Facebook import module 212, and Twitter®, which provides information about users and user profiles. The Facebook® import module can be used to import relevant end user data and a user profile into the database, such as a user's birthday or where the user lives or works, or the user's list of favorite things, so that more customized content can be delivered to the users by content providers (such as a birthday message). In an embodiment, the import manager handles the bulk transfer of data and information. The import manager also communicates with the administration module or administration API's 214 for obtaining input from system administrators, content producers or providers, and content users or consumers. The admin API module can be used to provide web interfaces for managing the system. By way of example only, the content providers or producers can include TV or movie producers or studios or networks or writers, record producers or song writers, internet content providers and online distributors of content such as Google®, Twitter®, TechCrunch®, Netflix®, iTunes®, and Hulu, and the like, game producers and social game producers such as Zynga® and Playdom®, and Electronic Arts, bloggers, social media providers such as FaceBook®, Google Plus® and MySpace®, and other media producers. System administrators will have access through the admin API's 214 in order to help troubleshoot any issues from both the content producers and the content users. The content providers or providers can have access to the import managers in order to set up new stories, modify and delete existing stories, and view statistics of their current story deployments. The content consumer interface, through the admin API's 214, can allow setting up new end user accounts, and allow current content users to view and modify their own data and subscribe to new stories. The content producers will thus be able to create and modify stories and to gather and monitor statistics. The Admin API 214 interface will allow the users to set up new end user accounts, and allow current users to view and modify their own data and subscribe to new stories. The admin API module can be used to provide web interfaces into managing the system. Through the use of dashboards and other input devices, as explained below, producers create the story line. Branch points in the story can lead the story and communication in a number of directions based on events, user input, user profiles and/or randomly and the like, and provide the triggers that trigger the various events and message communications.

As indicated above, a difference between the controller modules 102, 104, 106, 108, 110, and 112 in FIG. 1 and the controller modules 212 and 214 in FIG. 2, is the controller modules in FIG. 1 are generally meant for two-way communication with the end user or consumer and the database, while the controller modules in FIG. 2 are more for importing bulk data into the database from sources such as Facebook®, Google search®, Google Plus®, Twitter®, Yahoo®, Wikipedia®, YouTube®, email, voicemail, text messaging, blogs, and other data sources; however, modules 212 and 214 can also accommodate two-way communication. As an example, The Facebook® Import Module can input bulk data such as by way of example new user data (birthdates, email, phone, etc.). It is to be understood that although these embodiments are described in terms of storyline communications, other types of sequences and groups of events, and campaigns can be created, modified and monitored interactively, linearly and non-linearly, with these embodiments.

As is understood by one of ordinary skill in the art, the above systems and methods can be provided in systems that run on a computer as specified below.

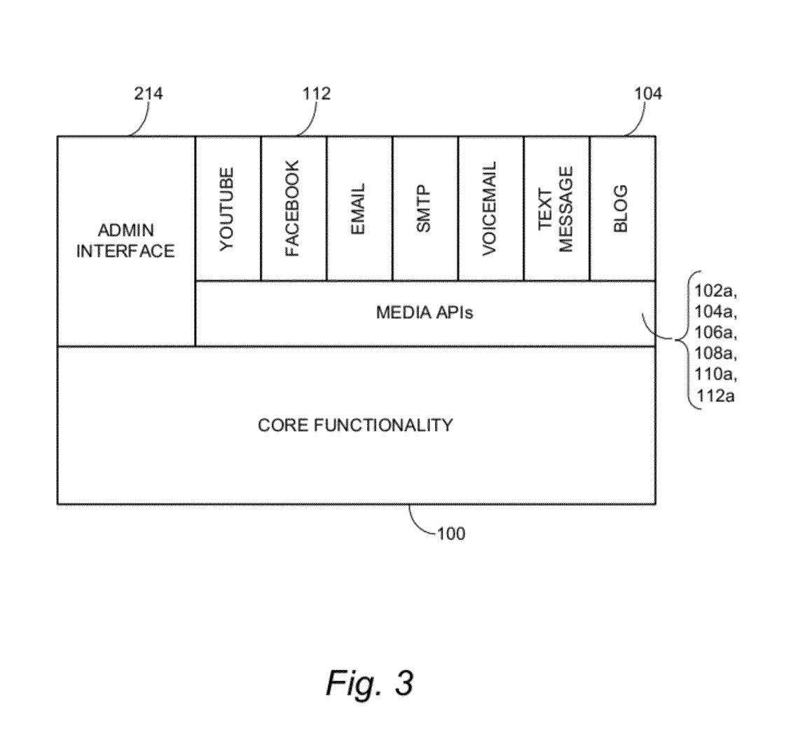

FIG. 3 depicts an architectural schematic of an embodiment of the present system and method of the invention with various communication modules in accordance with FIG. 2. With respect to the controller modules and by way of example only, the Facebook® Module 212 can integrate with character accounts such as story character profiles or user profiles, push status updates of data, and send Facebook® messages. The SMTP Modules can integrate with external SMTP servers and credentials, send emails and receive replies to emails and email receipts.

As indicated above, the Admin API's, as well as other modules, can be used by content producers to set up story campaigns. To support the campaign editing interface, the underlying TCS module can expose APIs for creating campaigns, creating full events, modifying individual parts of events, and deleting events.

The system admins have access to modify all the campaign and event data, as well as user accounts and system health. For this interface, additional module APIs can be for creating and modifying user accounts and for tracking important system health such as disk and memory usage.

A large portion of the server's interaction can be through software interfaces. For each social network and communication medium that the server can be integrating with, there can be a separate software module. In addition to being responsible for each medium's protocols to push content, each module can also be responsible for receiving back acknowledgement receipts that users have received or viewed the content.

### Content Producer Dashboard:

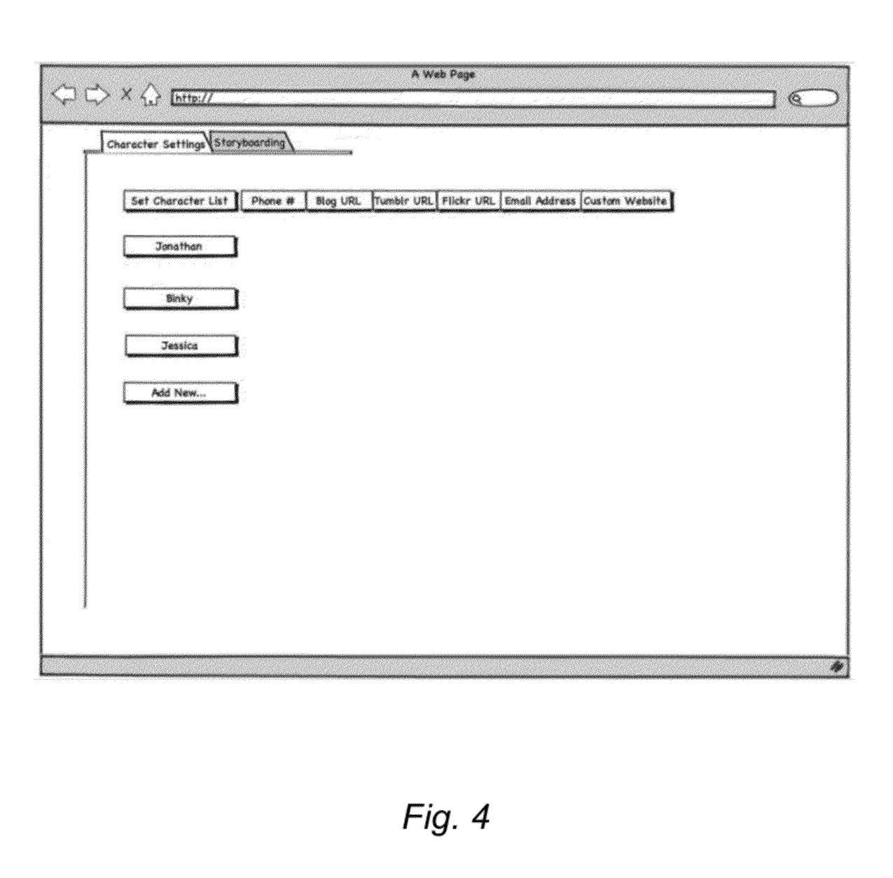

FIGS. 4 to 11 depict dashboards and input steps for use by a producer of a storytelling communication in accordance with embodiments of the invention. FIGS. 4 to 11 can be provided as a website (i.e. hosted on a website) or a spread sheet to a producer and used by the producer to prepare and organize a story to be consumed by a user. These dashboard images can be used to establish character or actor settings and profiles, define the story or storyboarding, and gathering or organizing analytics.

FIG. 4 is a dashboard used to set the values for the actors or characters who take part in the storyline. It is to be understood that these actors can, by way of example only, be fictitious or real, historical or currently living, and include the actual user that subscribes and participates in the story. FIG. 4 lists the actors and then provides for various forms of contact addresses for each of the actors listed. In addition to addresses for Facebook®, Twitter®, and other social networking cites can be listed.

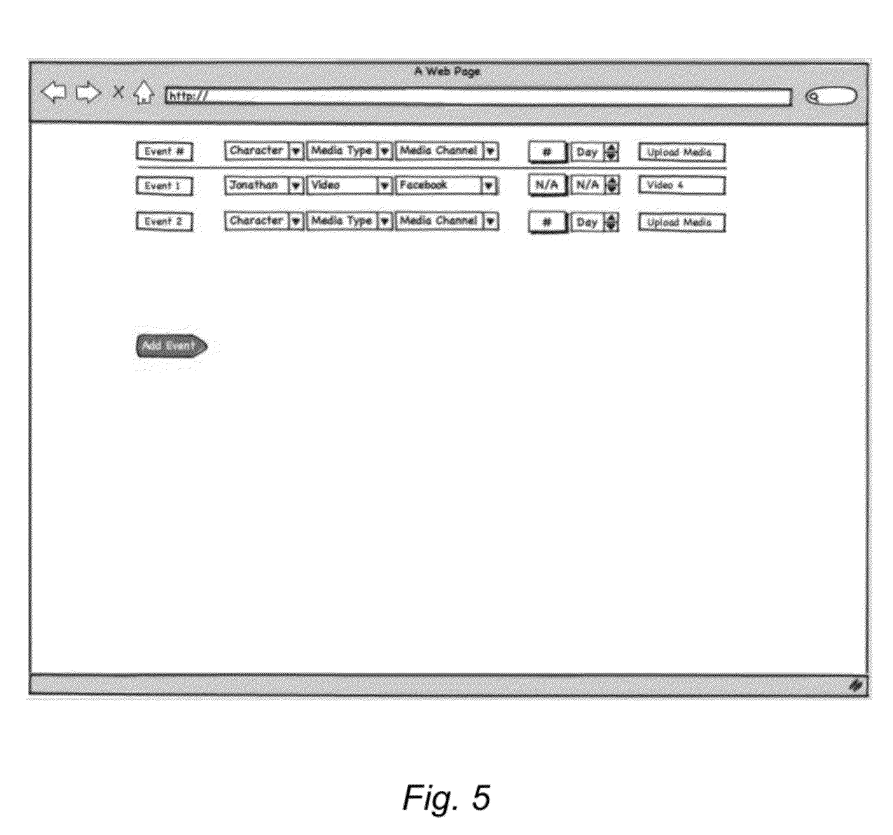

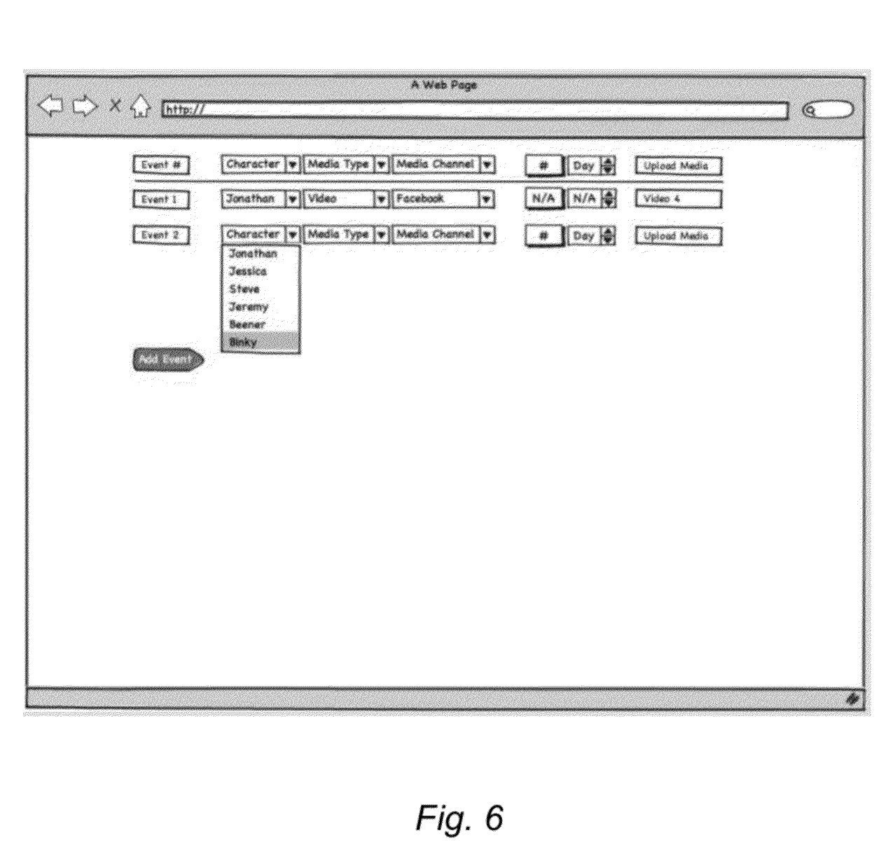

FIG. 5 is a storyboard dashboard that can be used by the producer to create an event, a story or other collection of events or to just add an event. As can be seen in FIG. 5 and the other FIGS. 6 to 11, events are scripted with the name of the character or actor, the type of media that will be used to create the event, the channel that media will be communicated to the actor, which can be a user or participant in the story, the time that the event will be triggered or communicated by the triggered communications server, and the actual location where the media is stored. A N/A status means that the event is to be triggered immediately. Still further, a random number or a time generator can be used to randomly select the timing or triggering of events. At randomly generated, or the producer and/or user selected times, content and events can be pushed to the user thorough the various media and media channels described herein.

FIG. 6 is similar to FIG. 5 with addition of another event with the character or actor and the media type and channel and the triggering information. In FIG. 6, another event is added and another character or story actor is selected.

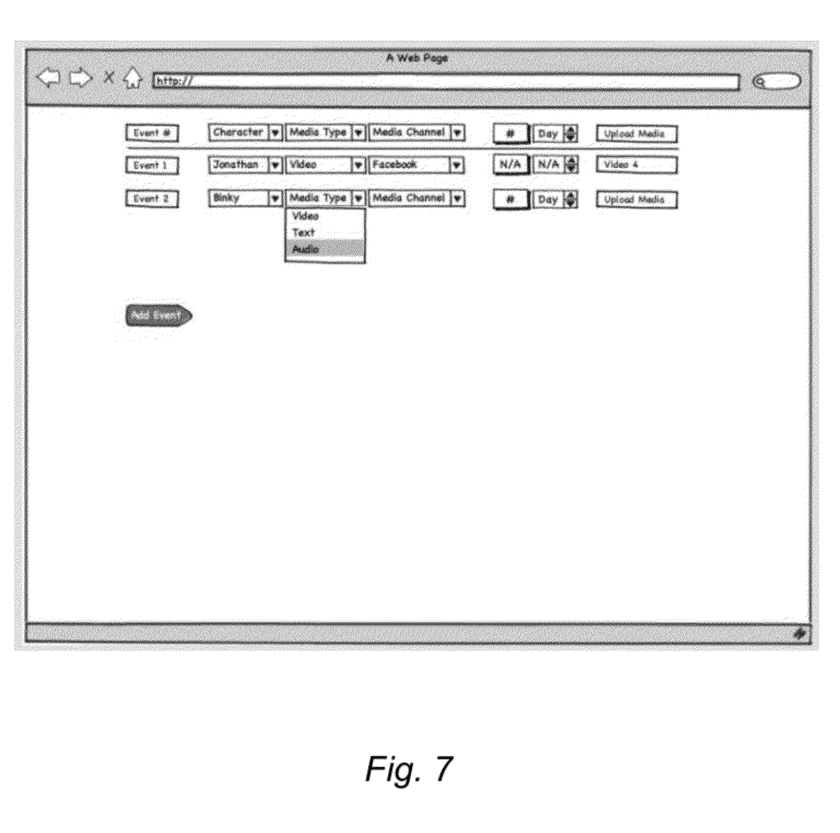

FIG. 7 is similar to FIGS. 5 and 6 with the media type added for the Event 2. It is to be understood that one event may have two or more characters involved. Thus for FIG. 7, there may be several rows with characters and media and triggering information for each event. In FIG. 7 under the field Media Channel, the producer can select the media channel to deliver the type of media selected.

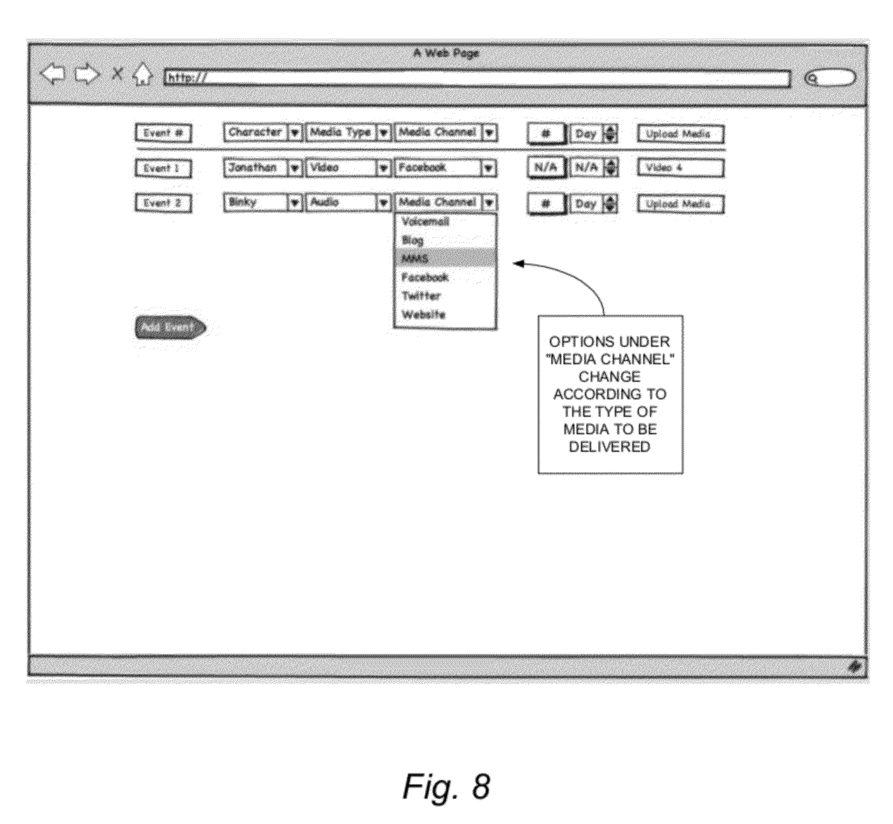

FIG. 8 is similar to FIGS. 5 to 7 with the media channel selected for Event 2. In this case a MMS or multimedia messaging service is selected as the media channel.

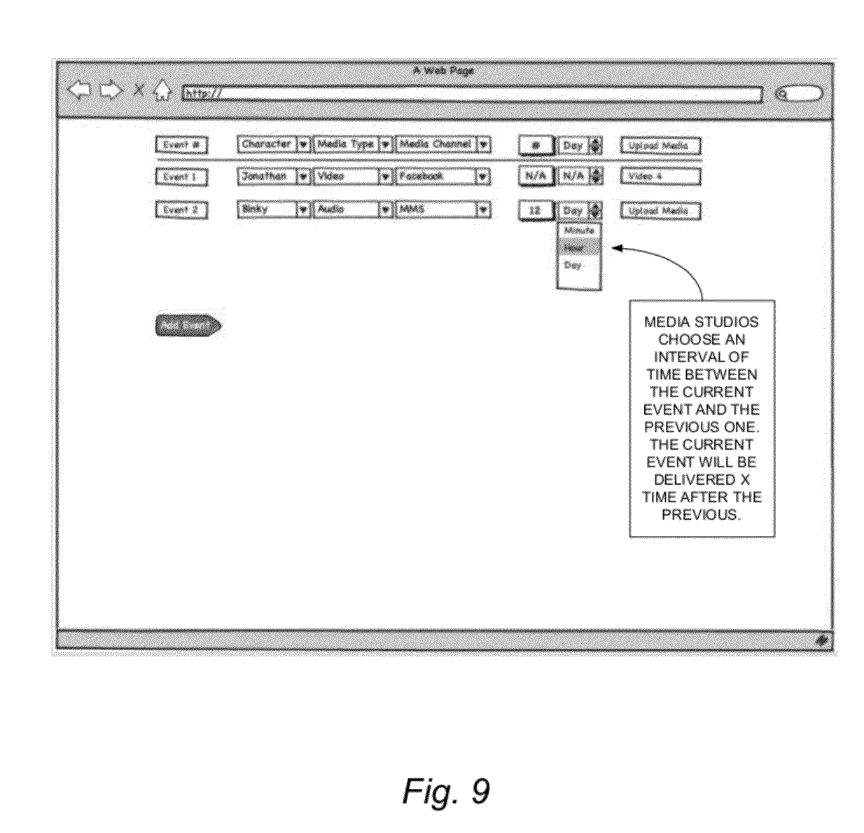

FIG. 9 is similar to FIGS. 5 to 8 with the time selected for triggering the Event 2 after Event 1 was triggered. The producers or media studios can chose an interval of time between the current event and the previous event. This can be chosen under the field designated at Day. The current event will be presented by that interval after the previous interval has been delivered.

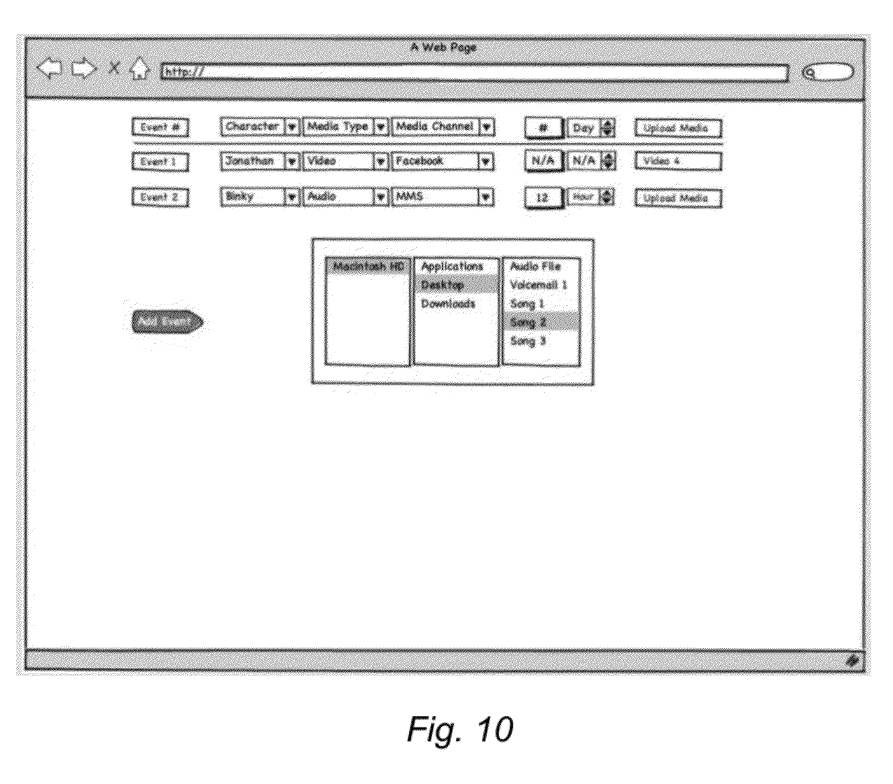

FIG. 10 is similar to FIGS. 5 to 10 with the media and the location of media designated. In this case the media is found on a desktop computer stored as an audio file as Song 2.

It is to be understood that each story can be personalized to the profile of the user. For example, the user's address and zip code can be used to personalize events that are triggered in the storyline. Certain media can be introduced into the event, such as pictures of the user's home based on the user's address to personalize the story. Interactions with local services or goods or actors, or contests in stores to name a few, can be prompted by the location of the user as given by a GPS tracking device, for example, associated with a mobile phone carried by the user. By way of example only, the PBX Module 108 can include a link to a G.P.S. tracking device located for example in a cell phone. Thus, the position of the user can be input to the TCS 100 and an event can be generated according to the position of the user. For example, a live actor can interact with the user if the user and live actor are in close proximity. Additionally, the user can be notified of a clue located in his vicinity, which clue can be the next event or prompt the next event. Using a location tracking device and based on the user's location the user can receive at least one of live events using one or more actors such as flash mobs, and offers and coupons relevant to a goods and services in the proximity of the user.

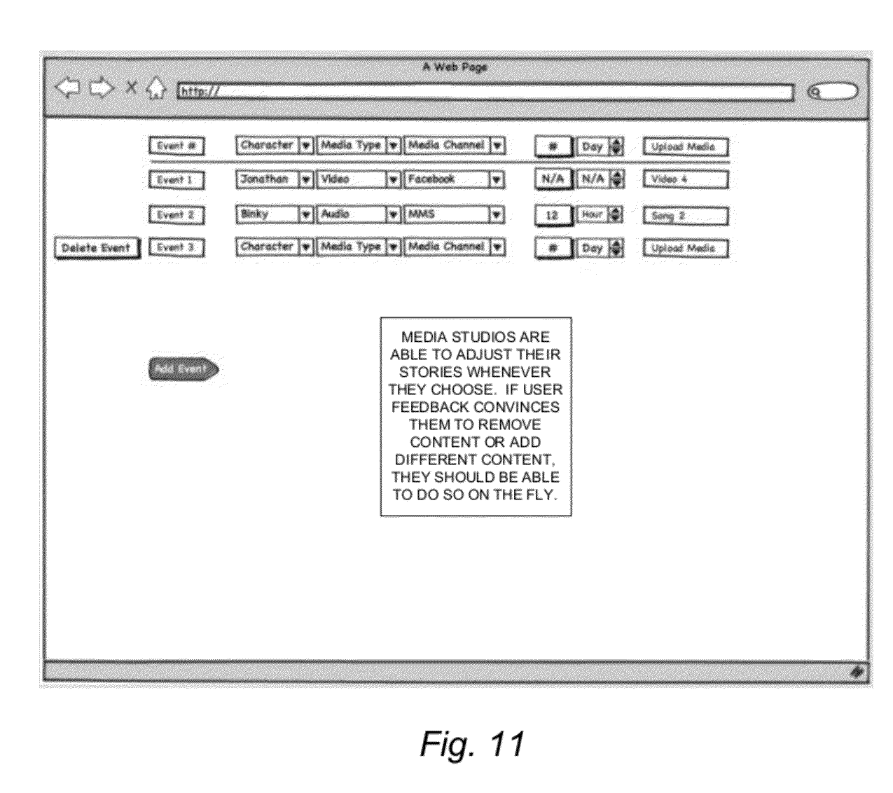

FIG. 11 demonstrates that the story producer can use the dashboard to modify, amend, delete or add events and the content and media for each event.

It is to be understood that the story and the events can be delivered over various types of hardware such as, for example, mobile, hand-held communication devices such as cell phones, land-line phones, wireless land-line phones, VOIP, laptops, desktops, palm tops, television sets, video projectors, mail, courier or delivery services, personal delivery, just to name a few. The media studios or producers can adjust their stories as they desire. In response to user feedback, either during the story or after, the media studios or producers can add content or remove content statically or on the fly. Such editing can be accomplished through the Admin APIs 214.

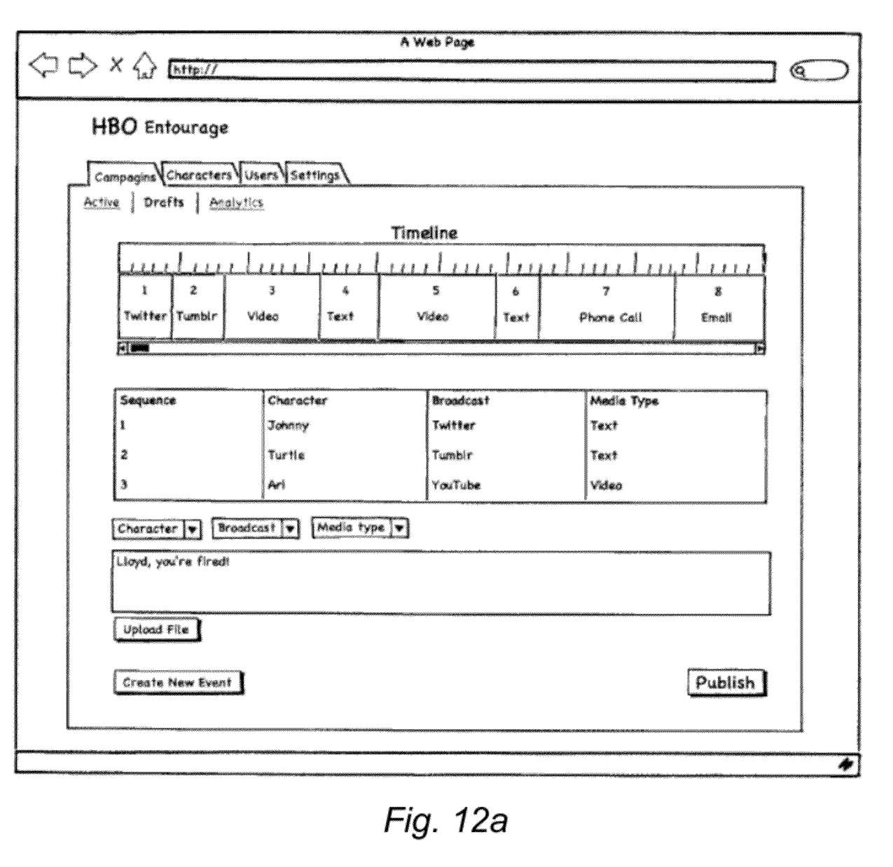

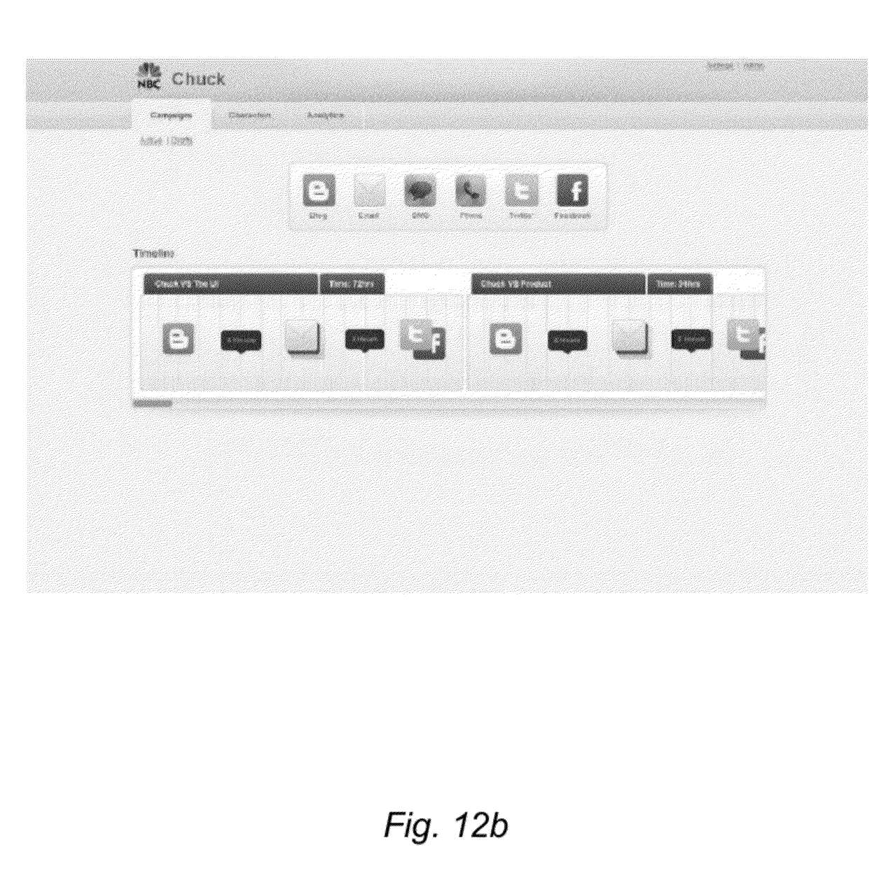

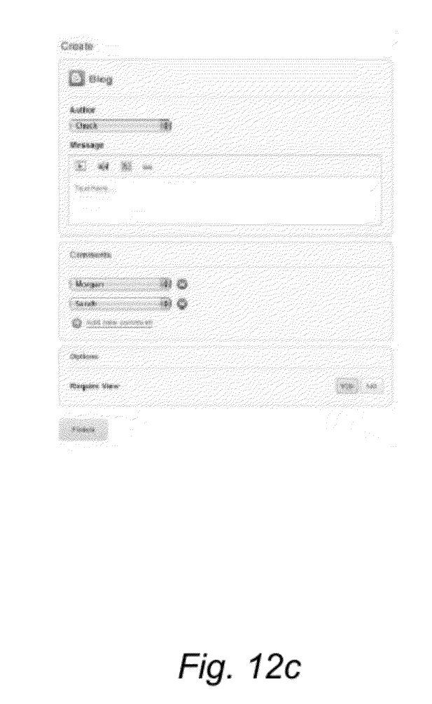

FIGS. 12a, 12b, and 12c depict input dashboards and steps that represent how a media producer can schedule events and channels of media to present different events in the communication, storytelling or learning environment. In FIG. 12a a campaign timeline is presented wherein the producer can schedule a sequence of events presented by various sources. For example, FIG. 12a shows a sequence of 8 events that can be scheduled over a timeline from sources such as Twitter®, Tumblr®, Video media, Text media, Video Media, Text media, Phone Call media and Email media. Each event in the sequence can introduce or add another character through one of the above events. For example, event 1 in the sequence introduces Johnny through Twitter® and a text medium. Event 2 in the sequence introduces Turtle through Tumblr® through text media. Event 3 in the sequence introduces An through YouTube® through a video media. New events in the sequence with new or the same characters, broadcast media and media type can be added by the producer.

FIGS. 12b and 12c show a campaign timeline that can be created by a producer where various media channels such as blog, email, SMS's, phone, Twitter® and Facebook® channels that can be used to deliver content to the user. FIG. 12b depicts two storylines with content delivered over intervals of time, with intervals of time between content delivery. FIG. 12c depicts input screens where the producer can create events using various media channels such as blogs, add various characters, and add various messages to the timeline.

It is to be understood that although the above embodiment has been directed to creating and delivering a story environment, that the embodiment can also be used to create an education or learning environment, a training environment or any other environment that is interactive and rich with media of all types and origins and content. The interactivity can be linear (one event following the facts of a prior event), non-linear (one event independent in time and/or space from a prior event), random (with a random event generator provided in the Chron Manager 206 that can completely randomly schedule events or can have a modified random scheduling scheme that for example randomly schedules follow-on events only when foundational information for the randomly scheduled event is presented prior to that random event.

The following are overviews of the embodiments of the system and method of the invention.

In these embodiments, emphasis is placed on the customization of the story telling to the behavior and habits and preferences and profile of the user. In other words, the story fits into how the user carries on activities during the day and multi-tasks a number of activities and events. User behaviors include being involved in the story at a number of times during the day, and with each involvement lasting a short amount of time, preferably in the range of 5 to 15 minutes. Thus, the user can proceed at his own pace. The story telling can also be user-driven based on the timing of the user input, and the content and context of the user input to the triggered events. Additionally, some stories may be used by the user to change user behaviors if the user so desires. Accordingly, for example, three or four short videos of between 5 to 15 minutes can be used during the day of a user to present the story. Thus, for example, long form media such as movies can be presented to users who have a short form or short event mindset or behavior pattern. As events are delivered to the user which are customized to the user's personal profile, the user can interact with the story and the user is or appears to be part of the story. Additionally, using the producer dashboard the story line can be amended in real time and adjusted in accordance with the feedback or sentiment of the user, with current events, with current news events, with popular trends, and/or with marketing incentives. Input from real time social media search engine results such as provided by Topsy®, based on the messages or Tweets® available from Twitter®, can be used to sample trends and preferences in real time and to adjust the story in accordance with events relevant to the user's profile and, for example, the user's current location or permanent address. Thus, in accordance with embodiments of the invention, stories or learning can be customized and personalized experiences for the user and adapt to the user's preferred engagement patterns. The engagement patterns can for example include preferred media presentation and delivery forms, preferred periods of engagement, whether a few minutes to several hours, and preferred intervals between periods of engagement to name a few. The embodiments can dynamically respond to the consumption patterns of the individual user as these patterns may change over a day, a week or a year or other time frame. As indicated above, media can be delivered by print, radio, film, online, text message, voice message, permanent storage, in person and live, just to name a few delivery modes.

The user can become part of the story or learning experience as the user and his profile is woven into the story or learning experience. The user can become one of the characters in the story environment. Small events throughout the day, week or month can be woven around the user or a group of users acting individually or a group of interactive users into an entire, cohesive, longer story or learning environment which interactively engages the user or users for a long period.

In embodiments of the invention the media can be delivered to the user and the user can interact by mobile devices such as cell phones and smart phones, tablet computers, desktop and laptop computers, live actors or events within the presence of the user, physical mail, video monitors, and any other mechanism to deliver content to the user. The embodiments of the invention can for example deliver one event per day or considerably more. Each event can take for example between thirty seconds and seven minutes or more to consume. The media can be sent to one user or can be broadcast to many users which users can act individually or interact as a group with each other.

The system also has an analytics module that can measure responses and output metrics about user behavior that can be used in the selection of events, media, media delivery channels, and triggering data. Analytics can also be used to evaluate the level of engagement of the user and assist in monetization based on the type of user and the extent of engagement of the user by way of example.

A number of methods can be used by the system to monetize the story telling (Table 1). The system can monetize such story telling by charging per event, by charging for bonus content per event or per story, by selling virtual and/or physical goods, by offering stories on a subscription basis, by charging for marketing targeted at the story line or the user's profile, and by in-story placement of branded goods or services. These monetization systems can be triggered and synchronized with the story and provided to the user by the triggered communications server. The below table depicts monetization opportunities which include by way of example only, charging per event, charging for virtual goods, charging for physical goods, charging by subscription, charging for accelerated or enhanced user involvement, and the like. Further user information can be used to have focused marketing directed at the individual users and the users interests and desires.

TABLE 1
MONETIZATION OPPORTUNITIES

| CHARGE PER EVENT | VIRTUAL GOODS | PHYSICAL GOODS | SUBSCRIPTION | TARGETED MARKETING |
|---|---|---|---|---|
| Charge by media | Micropayments (<$1) | Larger dollar amounts | Recurring monthly | Large user base with |
| content or per | | ($5-100+) | fee for “power- | multiple data points per |
| event (transmission | | | users” to unlock | user (age, gender, location, |
| from server to user) | | | bulk virtual goods | email, phone number) |
| Charge will vary | Frequent opportunities | Physical goods come in | Potential for one or | Constant push relationship |
| based on broadcast | to offer virtual goods | two flavors: | two physical goods | with users (producer |
| type (i.e. SMS vs. | to users (multiple | Memorabilia Display | per month to entice | expected to push content, |
| 5 min video) | virtual goods per event) | Items from the set | subscription | user expects to receive |
| | | Snail mail | | this content) |
| | | Signed photos | | |
| | | Product placement items | | |
| | | Clothes | | |
| | | Posters | | |
| Volume discounting | Wide range of virtual goods: | | Subscribers treated | Cross-sell stories, other |
| and various other | Extra content (e.g. back- | | as VIPs (visible on | media projects (e.g. film, |
| rates, bulk rate for | story, outtakes, outsider | | message boards) | TV) and general |
| leading content | character perspectives, | | Higher privileges | corporate branding |
| providers and users | extra photos and video | | than other users | |
| | content) | | | |
| | Personalized transmissions | | | |
| | from key characters - silent | | | |
| | auction for setting price. | | | |
| | Guest appearances | | | |

### Embodiments of use Cases:

### TV Serial Episode Story and Movie Storyline Extensions:

Storyline extensions can be produced for established serial presentations such television series and movie sequel series. For avid fans or to build a fan base, a series can be extended with events triggered using the embodiments described above to allow these series producers to deliver content to fans. As a use case, embodiments of the invention can be built on an existing fan base for a TV series and offer events with content and characters and storylines and events that are extensions of the TV series. Such an extension can continue to build loyalty among fans for the original TV series and for the extension built using the embodiments of the invention.

Content Producers such as major TV and movie studios may not know if a show is going to be a big success. For this reason, they try to extend existing successful shows as much as they can to get maximum value out of them. For example, instead of spending money creating a new TV show, a producer may rather create additional content for the TV show such as House, or engage users in a different way and at different time because they know House is popular and has a lot of interested fans.

Current methods to extend TV shows include webisodes, bonus content and Facebook® Fan Pages. Webisodes are 1-5 minute mini episodes that take place between the actual TV show. If House, for example, is on every Sunday at 8:00 p.m., there may be one or two webisodes on Tuesday or Thursday. These generally extend the storyline, or comment on past or upcoming content.

Bonus content generally consists of extra footage that did not make the cut or extra information for really engaged fans. Anthony Bourdain has bonus content online that big fans can watch after every show. He might tell you what he really thought of the food, or mention a few secrets about the show. The idea is to engage big fans through another medium, generate more viewer loyalty, and sell more advertising. Further, such channels of context, TV media and online media, can be offered simultaneously.

Facebook® Fan Pages offer a way for producers to have a presence on the largest social network. Fans of House can follow the “House Fan Page” and get updates about the show when they are on Facebook®. Fan Pages are more about community management than telling stories. It is more likely that a TV producer mentions a “House” contest on its Fan Page and/or reveals hints about next weeks episode.

The embodiment of this system offers a format for storytelling that big TV producers can use to extend their major shows. Dexter and House are generally only on for 4-5 months out of the year. Both between episodes and between season there is an opportunity for the producers to extend their shows by using this system. By using this system, these producers can extend existing successful stories to keep the experience fresh for viewers and users.

### Product or Service Presentations or Customized Commercials:

A storyline can be presented around the features, benefits, and uses of products that are relevant to the profile of the user. By participating in the story, the user can decide if the product or service is right for the user and experience the product or service in a virtually or non-virtual way, before actually making a purchase. The user can also earn or win samples of the product or services by participating in the storyline and, for example, responding to events triggered by the triggered communications server.

### Novels or Historical Fiction:

Content producers can product storylines that place the user in the setting of a novel or a historical fiction writing. The user can then experience and learn, for example, how a great philosopher thought by interacting with the storyline, or the user can be placed in an event of history and interact with events, prompted and suggested by historical facts.

### Educational use Case:

As people tend to learn faster and with greater understanding what they use with all of their senses (sight, sound, touch, smell and taste), materials that are delivered to the user for the user to interact with will be learned faster by the user when the user is immersed in a story delivered with various media and through various media channels that engage the servers of the user.

Another embodiment of the invention is a system comprising a triggered communications server for delivering various types of content, in various forms of media, in various channels of communication, at triggered intervals, and having the user participate and respond to the triggered events.

Another embodiment of the invention is a system comprising a server that delivered content from a story or series of events to a user based on the user's behavior patterns.

Another embodiment of the invention is a system comprising a triggered communications server that has a plurality of modules or adapters that can communicate with a plurality of communication channels for delivering media or address of media to a user, and also having input modules for the input of user profiles, stories and series of events as produced by producers with triggering commands, and system administration commands.

Another embodiment of the invention is a method that accomplishes the processes which the systems of the above embodiments perform.

Another embodiment of the invention is a triggered communications server in accordance with the systems of the above embodiments.

Another embodiment of the invention is a tool kit for developers and content producers that develop stories or a series of events, which includes a dashboard for setting up actor and user profile information, and for setting up events with characters, media, media types, media communication channels, triggering times, and locations for stored media or stored addresses for media.

Another embodiment of the invention is a system and method for providing a customized virtual world with a scripted story line with multiple subplots and story branches and transition points and multiple endings for individuals with individual profiles, and groups with group profiles.

Another embodiment of the invention is a system in accordance with any of the above embodiments wherein the context of the story is delivered by any possible medium including: the internet, text messages, voice mail, facsimile, cable, phone messages, video, staged scenes, live events, physical objects or presents or gifts or rewards or prizes, advertising, group meetings, parties, classroom experiences, plays, actors interacting on a real time basis with the user or participant, and any experience that can be sensed by one of the five senses of sight, hearing, taste, tough and smell.

Another embodiment of the invention is a system in accordance with any of the above embodiments that allows a user or participant to participate in a story or in a world all around the user and where the user lives.

Another embodiment of the invention is a system in accordance with any of the above embodiments that conforms the storyline and/or one or more events to the behavior patterns of the user.

Embodiments of the present invention may be conveniently implemented using one or more conventional general purpose or specialized digital computers or microprocessors. By way of example only, the TCS can run on a microprocessor with a memory device for the database. Various embodiments previously described include a computer program product which is a storage medium (media) having instructions stored thereon/in and which can be used to program a general purpose or specialized computing processor(s)/device(s) to perform any of the features presented herein. The storage medium can include, but is not limited to, one or more of the following: any type of physical media including floppy disks, optical discs, DVDs, CD-ROMs, micro drives, magneto-optical disks, holographic storage, ROMs, RAMs, PRAMS, EPROMs, EEPROMs, DRAMs, VRAMs, flash memory devices, magnetic or optical cards, nanosystems (including molecular memory ICs); paper or paper-based media; and any type of media or device suitable for storing instructions and/or information.

Various embodiments include a computer program product that can be transmitted in whole or in parts and over one or more public and/or private networks wherein the transmission includes instructions which can be used by one or more processors to perform any of the features presented herein. In various embodiments, the transmission may include a plurality of separate transmissions.

Stored one or more of the computer readable medium (media), the present disclosure includes software for controlling both the hardware of general purpose/specialized computer(s) and/or processor(s), and for enabling the computer(s) and/or processor(s) to interact with a human user or other mechanism utilizing the results of the present invention. Such software may include, but is not limited to, device drivers, operating systems, execution environments and containers, as well as user interfaces and applications.

The foregoing description of the preferred embodiments of the present invention has been provided for purposes of illustration and description. It is not intended to be exhaustive or to limit the invention to the precise forms disclosed. Many modifications and variations can be apparent to the practitioner skilled in the art. Embodiments were chosen and described in order to best explain the principles of the invention and its practical application, thereby enabling others skilled in the relevant art to understand the invention. It is intended that the scope of the invention be defined by the following claims and their equivalents.

What is claimed is:

1. A system for creating a communication environment comprising:
a triggered communications server which operates on a microprocessor and includes: an external module manager that is adapted to communicate to a user;
an event manager that can manage events that are provided to the user;
a chron manager that can schedule events that are provided to a user;
an import manager that is adapted to communicate with one or more sources of data; and
an administration module that are adapted to communicate with a producer of the communication environment;
wherein the triggered communications server can receive input and deliver content to the user in order to prevent a media rich interactive communication environment to the user and can receive input from the producer to create the communication environment for the user.

2. The system of claim 1 wherein said event manager and said import manager communicate with a database that can store user inputs and producer inputs.

3. The system of claim 1 wherein said external module communicates with controller modules that allow communication with the user through media sources such as blogs, video, SMTP, social networks, PBX's, VOIP, search engines and other media sources that can deliver content to the user and through which the user can deliver input to the triggered communication server in order for the user to participate in the communication environment.

4. The system of claim 1 wherein the import module can communicate with media sources such as blogs, video, SMTP, social networks, PBX's, VOIP, search engines and other media sources in order to provide bulk information about the user and the communication environment to the triggered communication server.

5. The system of claim 1 wherein the administration module is adapted to allow the producer to select events, the timing of events, characters, and story lines to be presented to the user selectively in a linear and/or non-linear order.

6. The system of claim 1 wherein the administration module presents a dashboard to the producer to allow the user to select one or more of characters, character profiles, character settings, media channels and media types to be delivered to the user, events to be delivered to the user, and the timing and sequence of events to be presented to the user.

7. The system of claim 1 wherein said triggered communications server is adapted to deliver content to a user in the form of s story or a series of events that are based on the user's behavior patterns.

8. The system of claim 1 wherein said triggered communications server is adapted to deliver to the user a customized environment with a scripted story line or plurality of events with branches and transition points and multiple endings for individual users based on individual profiles and individual user inputs and for groups of users with group profiles and group inputs.

9. The system of claim 1 including a tool kit that is adapted to be used by the producer and provides an input environment to the producer to allow the producer to select among story lines, a plurality of events, event timing, characters and character profiles, media and media channels to be delivered to the user.

10. The system of claim 1 wherein the triggered communications server can deliver to the user an interactive plurality of events that are selectively and/or randomly presented to the user, that are customized for the user, the user's profile, the user's interests, and the user's behavior patterns, and responsive to the user's input.

11. The system of claim 1 wherein said triggered communications server is adapted to deliver content and/or events to the user dependent on the location of the user.

12. The system of claim 1 wherein said event manager is adapted to receive user location information and deliver to the user events customized for the location of the user.

13. The system of claim 1 wherein the triggered communications server is adapted to receive inputs from the user from a mobile device that can determine user location and accept user location information along with the user input.

14. The system of claim 1 wherein said triggered communications server is adapted to deliver content and events to the user dependent on the user's behavior patterns as determined by at least one of the user's profile and determined in real time in accordance with the user's interactive response patterns.

15. The system of claim 12 where the triggered communications server can deliver to the user based on the user's location at least one of live events using one or more actors such as flash mobs, and offers and coupons relevant to a goods and services in the proximity of the user.

16. The system of claim 1 wherein said triggered communications server is adapted to deliver to the user extended content about a television series and/or movie, a current event, a live event prior to, simultaneously with, or subsequently to the television series and/or movie, current event and live event.

17. A method for creating a media rich, linear and/or non-linear and/or random, interactive communication, education and/or story telling environment using a microprocessor comprising the steps in any order of:
allowing a user to input information and responses and receive information and responses from a triggered communications server through an external module manager that manages user input devices;
allowing an event producer to input events, timing of events, event information, and story lines to the triggered communications server through an administration module;
allowing bulk content, information and data about users and events to be imported into a database that can communicate with the event manager to deliver selective portions of the bulk content, information and data to the user at selected times and intervals responsive to the inputs of the user and the inputs of the producer; and
allowing events and information to be delivered to the user based on the user' behavior patterns.

18. The method of claim 17 wherein said first allowing step allows the user to communicate using media sources such as blogs, video, SMTP, social networks, PBX's, VOIP, search engines and other media sources that can deliver content to the user and through which the user can deliver input to the triggered communication server in order for the user to participate in the environment.

19. The method of claim 17 wherein the third allowing step allows bulk content, information and data to be received from media sources such as blogs, video, SMTP, social networks, PBX's, VOIP, search engines and other media sources in order to provide bulk information about the user and the communication environment to the triggered communication server.

20. Non-transitory computer medium that can run on a microprocessor comprising:
a triggered communications server which operates on the microprocessor and includes: an external module manager that is adapted to communicate to a user;
an event manager that can manage events that are provided to the user;
a chron manager that can schedule events that are provided to a user;
an import manager that is adapted to communicate with one or more sources of data; and
an administration module that are adapted to communicate with a producer of the communication environment;
wherein the triggered communications server can receive input and deliver content to the user in order to prevent a media rich interactive communication environment to the user and can receive input from the producer to create the communication environment for the user.

21. A system for creating an environment for a user comprising a triggered communications server to deliver various types of content, in various forms of media, in various channels of communication, at various intervals, responsive to a user's profile and history and behavior, and responsive to a user's inputs and that is adapted to allow a user to participate and respond to the triggered events.
